(19) United States
(12) Patent Application Publication
(10) Pub. No.: US 2001/0052747 A1
(43) Pub. Date: Dec. 20, 2001

(54) Color cathode ray tube and electron gun

(75) Inventors: Reiner Maria Jungbult, Eindhoven (NL); Ronald Van Der Wilk, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/883,430

(22) Filed: Jun. 18, 2001

(30) Foreign Application Priority Data
Jun. 19, 2000 (EP) 00202140.0

(51) Int. Cl. H01J 29/50

(52) U.S. Cl. 313/413; 313/421; 313/414

(57) ABSTRACT

The invention relates to a color cathode ray tube. The color cathode ray tube comprises a display screen, an electron gun for generating three electron beams, wherein the electron beams are directed towards the display screen. Also deflection means are present for generating a magnetic field in a first direction for deflecting the electron beams across the display screen. The electron gun comprises a centering cup having a first part provided with a central aperture and two outer apertures for passing the three electron beams, and a second part extending in the direction of the display screen. The centering cup of the electron gun is provided with two bridges creating the slits between the first part and the second part of the centering cup, such that a first line drawn between a first end of the first bridge and a first end of the second bridge intersects a second line drawn between a second end of the first bridge and a second end of the second bridge, and the bisectrix of the intersecting lines is substantially parallel to the first direction in order to reduce the eddy currents in the centering cup.

The invention relates to a cathode ray tube as defined in the precharacterizing part of claim 1.

The invention further relates to an electron gun for use in such a color cathode ray tube.

Color cathode ray tubes are used, inter alia in color television receivers and color monitors.

A color cathode ray tube is known from WO 97-07523. This document discloses a color cathode ray tube comprising an electron gun having a centering cup and a deflection unit. In operation, the deflection unit generates an electromagnetic field for deflecting the electron beams generated by the in-line electron gun on the display screen. Furthermore, the electron gun and the deflection unit are designed in such a way that the electron beams are converged on the display screen. The high-frequency deflection field induces eddy currents in the centering cup. These eddy currents have a negative influence on the image quality and the sensitivity of the deflection unit. Also the sensitivity of possible scan velocity modulation coils or dynamic convergence coils is reduced. The image quality is determined, inter alia, by the convergence of the electron beams on the display screen. Furthermore, the centering cup provides a high-voltage contact between the main lens of the electron gun with a conductive layer on the inner side of the cathode ray tube. The conductive layer and the centering cup overlap in an axial direction of the cathode ray tube to avoid high-voltage discharges, sparks etc. These high-voltage problems can be reduced by extending the length of the centering cup. However, longer centering cups increase the eddy currents induced by the electromagnetic field of the deflection unit. To mitigate the electromagnetic effect of the induced eddy currents on the electron beams in the known cathode ray tube, the centering cup is provided with four slits. The four slits are positioned mirror-symmetrically with respect to the in-line plane and with respect to a plane perpendicular to the in-line plane through the central aperture. Although these slits reduce the electromagnetic effects of the eddy currents on the electron beam to a certain extent, the interaction between the electromagnetic field of the deflection unit and the electron gun becomes stronger in a shallower color cathode ray tube, while the eddy currents increase and the influence on the electron beam is increased. Furthermore, switching between lower and higher deflection frequencies, for example, between 64 KHz and 95 KHz may introduce substantial changes in the convergence of the electron beams due to the difference in heating of the centering cup and parts of the main lens by the eddy currents induced at the different frequencies.

It is an object of the invention to further reduce the eddy currents in the centering cup.

This object is achieved by a color cathode ray tube in accordance with the invention as defined in claim 1. The invention is based on the recognition that, in a centering cup without any slits, the currents induced by the inhomogeneous high-frequency deflection field flow in circles, starting in the second part of the centering cup through the plate of the first part of the centering cup. Due to the proposed position of the slits, the induced eddy currents are reduced and hence heating of the centering cup is reduced. This reduction is significant especially at higher frequencies of the deflection field, for example, 95 KHz. The thermal expansion due to heating of the centering cup and the connected main lens may introduce a mechanical deformation of the centering cup and main lens parts, leading to a reduction of the convergence of the electron beams on the display screen. Although the slits in the known cathode ray tube also reduce the eddy currents, these slits do not reduce the eddy currents, i.e. the heating of the cup as effectively as the slits according to the invention. In the known cathode ray tube, the slits are designed to avoid dynamic convergence errors introduced by the eddy currents, whereas the slits in the cathode ray tube according to the invention reduce the eddy currents in such a way that their influence on the dynamic convergence is within acceptable limits and heating of the centering cup and parts of the main lens does not substantially affect the convergence of the electron beams. This allows the designers of cathode ray tubes to position the electron gun further in the deflection field, thereby creating a shallower cathode ray tube. A further advantage is that shallower cathode ray tubes can be designed without reducing an overlap between the deflection parts and the electron gun parts, thereby avoiding high-voltage problems such as high-voltage discharges and sparks.

In an embodiment of the cathode ray tube in accordance with the invention, the slits interrupt most of the eddy current circles running through the plate of the centering cup and the jacket. The bridges between the first and the second parts are positioned close to the center of the current circles, corresponding to positions on a centering cup without any slits where the induced eddy currents are almost equal to zero. In this way, the distribution of the eddy currents is changed and the contribution to the total eddy currents is low as compared with a centering cup with the slits of the known cathode ray tube.

A further embodiment of the cathode ray tube according to the invention is defined in claim 3. This allows easy manufacturing of the centering cup, while the slits can be cut in the walls of the centering cup.

Further embodiments are defined in the dependent claims.

These and other aspects of the invention are apparent from and will be elucidated with reference to the embodiments described hereinafter.

In the drawings:

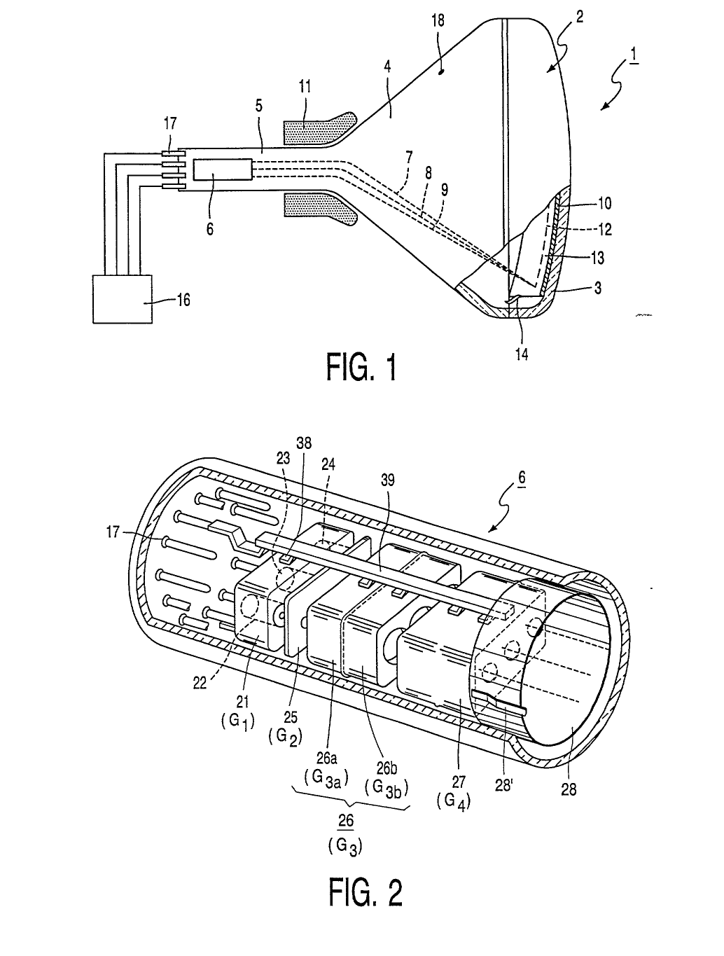

FIG. 1 is a longitudinal section of a color cathode ray tube according to the invention,

FIG. 2 is a perspective view of an electron gun used in the color display tube of FIG. 1,

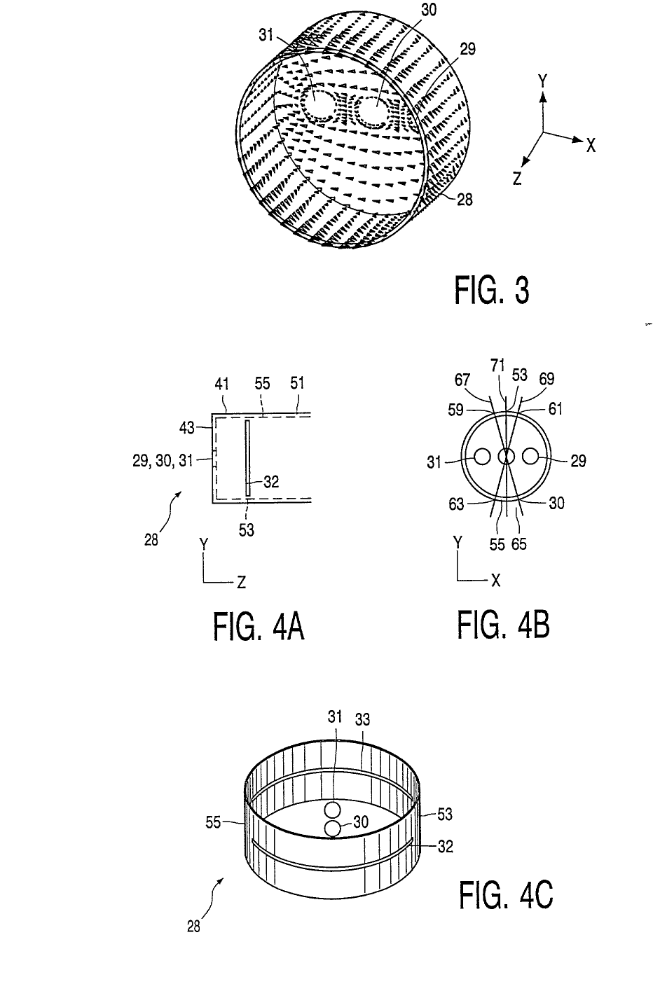

FIG. 3 is a perspective view of a centering cup without slits,

FIGS. 4A to 4C are a side view, top view and perspective view, respectively, of a centering cup with slits,

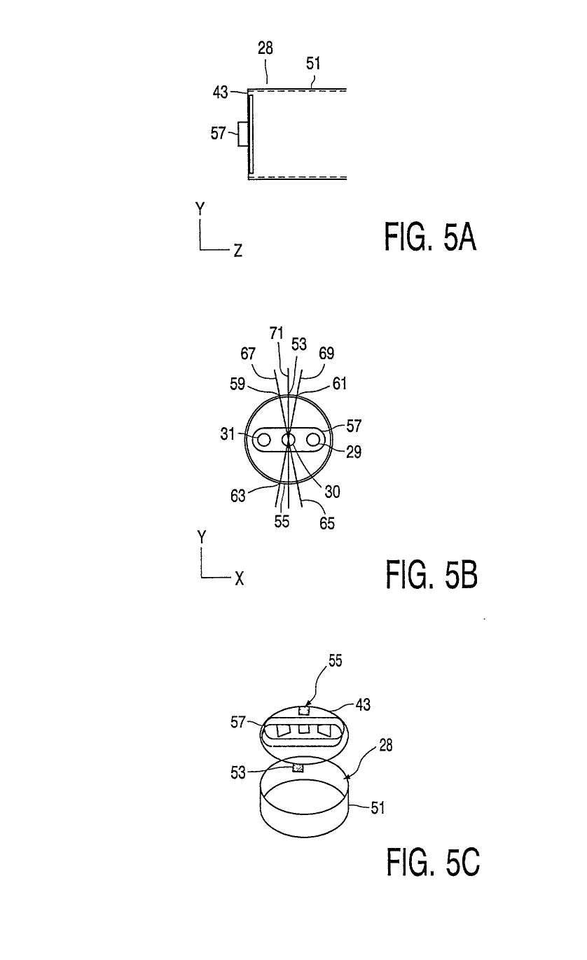

FIG. 5 shows, in a graphical form, the dependency of the convergence error Δ on the position of the slits,

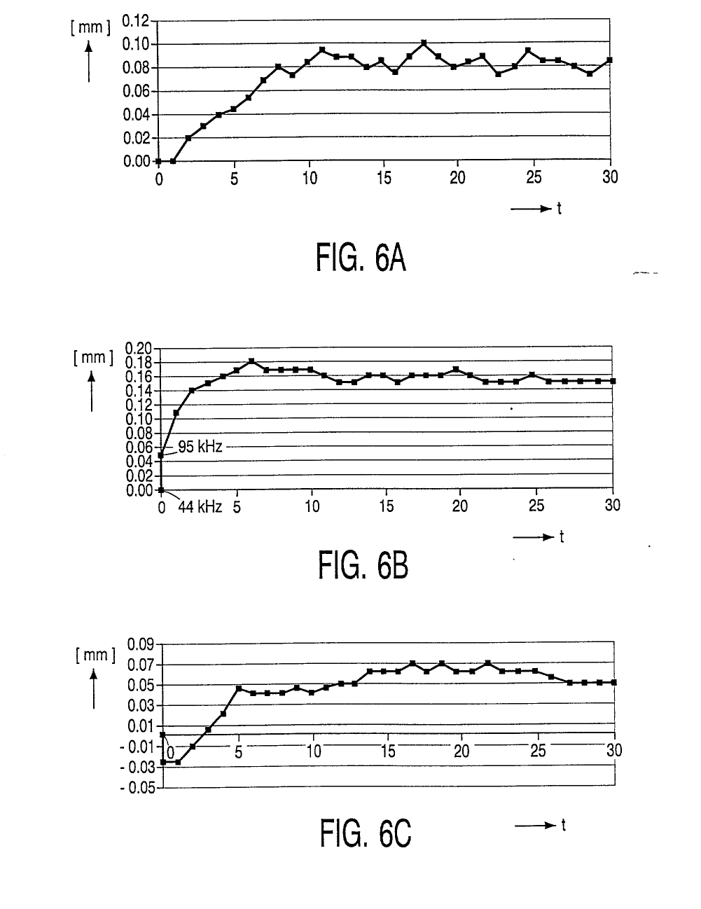

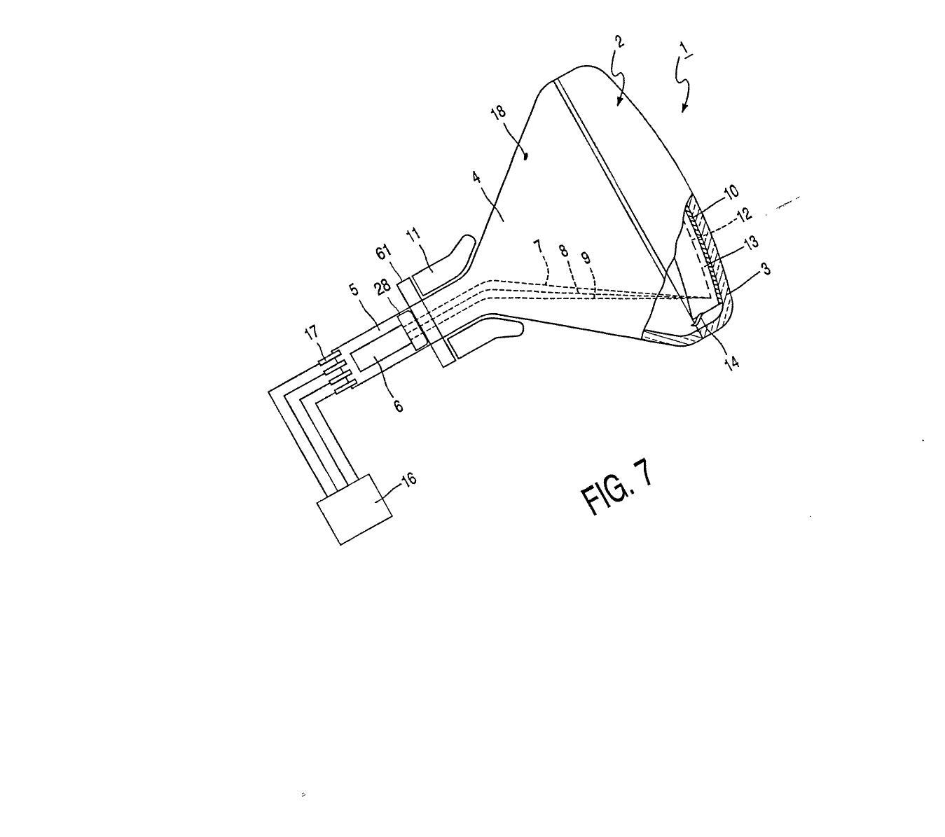

FIG. 6 shows a longitudinal section of a further embodiment of a color cathode ray tube according to the invention, and

FIG. 7 shows an embodiment of a color cathode ray tube with an additional coil in front of the deflection unit.

FIG. 1 shows an example of a color display tube of the “in-line” type in a longitudinal section. In a glass envelope 1, which is composed of a display window 2 having a face plate 3, a cone 4 and a neck 5, this neck accommodates an integrated electron gun system 6 which generates three electron beams 7, 8 and 9 whose axes are located in the plane of the drawing. The axis of the central electron beam 8 initially coincides with the tube axis. The inner side of the face plate 3 is provided with a large number of triplets of phosphor elements. The elements may consist of lines or dots. Each triplet comprises an element consisting of a blue-green luminescing phosphor, an element consisting of a green luminescing phosphor and an element consisting of a red-green luminescing phosphor. All triplets combined constitute the display screen 10. The three co-planar electron beams are deflected by deflection means, for instance, by a system of deflection coils 11. Positioned in front of the display screen is the shadow mask 12 provided with a large number of elongated apertures 13 through which the electron beams 7, 8 and 9 pass, each impinging only on phosphor elements of one color. The shadow mask is suspended in the display window by means of suspension means 14. The device further comprises means 16 for supplying voltages to the electron gun system via feedthroughs 17. The color cathode ray tube also comprises a so-called anode button 18. This anode button 18 is a high-voltage lead through which, in operation, a high-voltage is supplied to a third focusing electrode via a conducting layer on the inner side on the cone of the envelope.

FIG. 2 is a perspective view of an electron gun used in the display tube shown in FIG. 1.

The electron gun system 6 comprises a common control electrode 21, also referred to as the G1-electrode, in which three cathodes 22, 23 and 24 are secured. In this example, the G1-electrode forms the first pre-focusing electrode of the pre-focusing part of the electron gun. The electron gun system further comprises a common plate-shaped electrode 25, also referred to as the G2-electrode, which forms the second pre-focusing electrode of the pre-focusing part of the electron gun. The electron gun system further comprises a third common electrode 26, also referred to as the G3-electrode, which electrode comprises two sub-electrodes 26a and 26b (also referred to as the G3a and G3b-electrode). Sub-electrode 26a forms the first focusing electrode, and sub-electrode 26b forms the second focusing electrode. The electron gun further comprises a final accelerating electrode 27, (also referred to as the G4-electrode), which forms the third focusing electrode. All electrodes are connected via braces 38 to a ceramic carrier 39. Only one of these carriers is shown in this Fig. The neck of the envelope is provided with electric feedthroughs 17. Electric connections between the feedthroughs and some of the electrodes are schematically shown in FIG. 2. At the end facing the display screen, the electron gun also comprises a centering cup 28. Said centering cup is usually provided with centering springs 28′, of which, for simplicity, only one is shown in FIG. 2. Said centering springs connect to the conducting layer on the inner side of the cone.

FIG. 3 is a perspective view of a centering cup 28. The centering cup 28 is provided with three apertures 29, 30 and 31 for passing the electron beams 7, 8 and 9. The apertures are situated in an in-line plane, in this Fig. the x-z plane. The centering cup is usually made of non-ferromagnetic material. The high-frequency deflection field generated by the deflection unit 11 induces eddy currents in the centering cup, which eddy currents reduce the quality of the image. FIG. 3 shows by means of arrows a simulation of the intensity of the eddy currents. The eddy currents are concentrated above and below (viewed in the y-direction) the central aperture 30.

FIGS. 4A to 4C are a side view, top view and perspective view, respectively, of a centering cup 28 with slits 32, 33. The centering cup 28 of FIG. 4 has a first cylindrical part 41 comprising a plate 43 provided with a central aperture 30 and two outer apertures 29,31 for passing the three electron beams, and a second cylindrical part 51. The centering cup 40 is provided with two bridges 53,55 for connecting the first and second parts 41, 51 of the centering cup, thereby creating the slits 32,33 between the first and second cylindrical parts 41,51. Within the framework of the invention, it has been found that the positions of the bridges with respect to the high-deflection magnetic field are important. The dimensions of the respective bridges 53,55 creating the slits between the first and second cylindrical parts 41,51 are such that a first line 67 drawn between a first end 59 of the first bridge 53 and a first end 65 of the second bridge 55 intersects a second line 69 drawn between a second end 61 of the first bridge 53 and a second end 63 of the second bridge 55, and the bisectrix 71 of the intersecting lines 67,69 is substantially parallel to the first direction of the high-frequency deflecting magnetic field. Preferably, the slits 32, 33 are positioned substantially parallel to the plate 43 and the lengths of the slits 32,33 are at least 50% of the diameter of the centering cup 28 for an effective reduction of the eddy currents.

FIGS. 5A to 5C are a side view, top view and perspective view, respectively, of a centering cup 28 with slits 32, 33. The centering cup 28 of FIG. 4 has a first part comprising an insert 57 of the main lens and a single plate 43 provided with a central aperture 30 and two outer apertures 29,31 for passing the three electron beams, and a second cylindrical part, for example, the jacket 51. The plate 43 of the centering cup 40 is provided with tongues 53,55 forming the two bridges with the jacket 51 for connecting the plate 43 and the jacket 51 of the centering cup, thereby creating the slits 32,33 between the plate 43 and the jacket 51. The slits 32,33 reduce the eddy currents in the centering cup. Preferably, the slits are positioned substantially parallel to the plate. The dimensions and positions of the respective bridges 53,55 creating the slits 32,33 between the plate 43 and the jacket 51 are such that a first line drawn 67 between a first end 59 of the first bridge 53 and a first end 65 of the second bridge 55 intersects a second line 69 drawn between a second end 61 of the first bridge 53 and a second end 63 of the second bridge 55, and the bisectrix 71 of the intersecting lines 67,69 is substantially parallel to the first direction of the high-frequency deflecting magnetic field. Preferably, the lengths of the slits 32,33 are at least 50% of the diameter of the centering cup 28 for an effective reduction of the eddy currents.

FIGS. 6A to 6C shows the effect of the slits on the convergence error. When a convergence error occurs, the outer electron beams do not coincide with the central electron beam on the display screen, which non-coincidence causes a distortion of the image displayed on the screen. The convergence errors of the cathode ray tubes, due to heating of the centering cup and parts of the main lens, can be compensated for a predetermined frequency of the magnetic field generated for the line deflection. For example, the convergence error can be compensated by means for generating a biasing magnetic field to compensate the convergence error. These means may be, for example, a ring of hard-magnetic material in the centering cup. This ring is positioned in the centering cup. During manufacture of the cathode ray tube in a first step, the convergence error for the predetermined frequency is measured for a cathode ray tube without the biasing magnetic field of the ring. In a subsequent step, the biasing magnetic field strength of the ring is calculated for compensation of this convergence error, and the hard-magnetic material of the ring is magnetized so as to provide this calculated biasing magnetic field strength. However, when the frequency of the high-frequency deflection field is changed to a second predetermined frequency, the convergence error of the cathode ray tube may be increasing to a higher value due to further thermal expansion of the ring and main focus parts at increasing temperatures corresponding to higher eddy currents related to the second higher frequency, for example, when the cathode ray tube is switched from a low to a high resolution mode. In this example, the first frequency of the high-frequency deflection field in the low resolution mode is 44 kHz and the second frequency of the high-frequency deflection field in the high resolution mode is 95 kHz. FIGS. 6A, 6B en 6C show the non-convergence of the electron beams on the display screen as a function of time after the display has been switched from the first to the second mode. In FIGS. 6A,6B and 6C, the convergence error is given as an absolute value in millimeters. FIG. 6A shows a graph of the convergence error of a 19″ cathode ray tube with an electron gun having a relatively long centering cup with a length of 13 mm and two slits in accordance with the position as described with reference to FIG. 4. The dots in FIG. 6A, through which, for guidance of the eye, a full line 61 is drawn, are the results of measurements for a centering cup having a length of 13 mm and two slits. In this example, the width of the slits is 0.1 mm and the width of the bridges is 5 mm and configured according to FIG. 4.

FIG. 6B shows a graph 62 of a convergence error of a cathode ray tube with an electron gun having a relatively long centering cup with a length of 13 mm without slits. FIG. 6C shows a graph 63 of a conventional cathode ray tube with an electron gun having a conventional centering cup with a length of 6.5 mm.

FIG. 6A and FIG. 6B show that the position of the slits reduces the eddy currents significantly, and the convergence error is reduced from 0.15 mm to 0.09 mm and may be further reduced to 0.05 mm.

FIG. 6C shows a graph of the convergence error of a conventional cathode ray tube and a conventional centering cup with a length of 6.5 mm. The convergence drift of the cathode ray tube with the new centering cup approaches the convergence drift of the shorter conventional cup. The new design allows a shallower design of the cathode ray tube, while problems with high voltage and loose particles are reduced.

FIG. 7 shows a cathode ray tube for which the invention is particularly advantageous. An additional coil 61 for generating an alternating electromagnetic field is provided around the neck, in front of the deflection unit. Such a coil may be, for instance, a Scan-Velocity Modulating coil. When such additional fields are used, the eddy currents in the centering cup are particularly strong and can be reduced significantly with the centering cup as described above.

1. A color cathode ray tube comprising a display screen, an electron gun for generating three electron beams, said electron beams being directed towards the display screen, and deflection means for generating a magnetic field in a first direction for deflecting the electron beams across the display screen, said electron gun comprising a centering cup having a first part provided with a central aperture and two outer apertures for passing the three electron beams, and a second part extending in the direction of the display screen for avoiding sparks, the centering cup being provided with slits for reducing the effects of eddy currents, characterized in that the centering cup comprises a first bridge and a second bridge creating the slits between the first and second parts, such that a first line drawn between a first end of the first bridge and a first end of the second bridge intersects a second line drawn between a second end of the first bridge and a second end of the second bridge, and the bisectrix of the intersecting lines is substantially parallel to the first direction.

2. A color cathode ray tube as claimed in claim 1, characterized in that the first part comprises a plate provided with the central aperture and the two outer apertures, the slits being substantially parallel to the plate.

3. A color cathode ray tube as claimed in claim 1, characterized in that the lengths of the slits are at least 50% of the diameter of the centering cup.

4. A color cathode ray tube as claimed in claim 1, characterized in that the second part comprises a circular symmetric jacket.

5. A color cathode ray tube as claimed in claim 1, characterized in that the first and second parts comprise respective circular symmetric jackets.

6. A color cathode ray tube as claimed in claim 1, characterized in that the centering cup is provided with a ring comprising a ferro-magnetic material.

7. A color cathode ray tube as claimed in claim 1, characterized in that the slit has a width of about 0.1 mm.
